(19) United States
(12) Patent Application Publication
(10) Pub. No.: US 2006/0171385 A1
(43) Pub. Date: Aug. 3, 2006

(54) Data protection method and relay equipment using the same

(75) Inventors: Mikio Itou, Kawasaki (JP); Norio Nakamura, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/136,937

(22) Filed: May 25, 2005

(30) Foreign Application Priority Data
Feb. 3, 2005 (JP) 2005-28230

(51) Int. Cl. H04L 1/00

(52) U.S. Cl. 370/389; 370/242

(57) ABSTRACT

Store-and-forward relay equipment in which received data are temporarily stored in a buffer and then transmitted is provided. In the equipment, protection is performed with the limitation of the data part, which is not an object for substitution operation inside the equipment and has an unchanged content. As to the frame received, the part on which no operation is performed inside the equipment is determined, and the CRC for the part concerned is calculated. The obtained CRC is added to a CRC for inside the equipment in the frame. A data error produced inside the equipment is detected for the part on which no operation is performed. A data error produced in the header part of the substitution object in the equipment is not protected by the above CRC for inside the equipment. However, the header part is inspected through the protocol processing.

### BACKGROUND OF THE INVENTION

1. Field of the Invention The present invention relates to store-and-forward relay equipment in which received data are temporarily stored in a buffer and then transmitted.

2. Description of the Related Art

The relay equipment described here denotes router, L3 switch and L2 switch (switching hub) which perform relay processing according to L2 and L3 headers in a received frame, by appropriately performing rewrite (substitution) operations of the headers in the course of the relay processing.

In a network system used for financial services and the like, high reliability of 100% data guarantee is required.

In FIG. 1, an exemplary configuration block diagram of the conventional store-and-forward relay equipment is shown. Also, FIG. 2 shows a frame flow in the relay equipment shown in FIG. 1.

A MAC interface 1 at the input site receives, from a transmission line, a frame having CRC (cyclic redundancy check) bits for the transmission lines (step S1).

Here, the detail frame format having the CRC for the transmission lines is shown in FIG. 3.

The frame includes an L2 header and an L3 header followed by data, and CRC (cyclic redundancy check) bits thereafter.

The relay equipment such as router, L3 (layer 3) switch and L2 (layer 2) switch performs L2 relay processing or L3 relay processing, and performs a rewrite (substitution) operation of the L2 header in case of the L2 relay, or both the L2 header the L3 header in case of the L3 relay.

The cyclic redundancy check (CRC) is an error detection system capable of detecting errors which appear contiguously (burst error). In the Ethernet frame, a CRC value calculated for an overall frame is set in the FCS (frame check sequence) field so as to detect a frame error produced on the transmission line. The term ‘CRC for the transmission lines’ denotes this kind of CRC.

In order to distinguish the above CRC from the ‘CRC for inside the equipment’ being applied in the present invention, in the following description, the term ‘CRC for the transmission lines’ will be used for convenience.

Further, in FIG. 3, the L2 header includes destination MAC address I, source MAC address II, VLAN tag III, and type IV. The VLAN tag III includes TPID IIIa (where TPID denotes tag protocol identifier: consisting of 2 bytes, having 0x8100 in case of the Ethernet. When the TPID is other than 0x8100, the frame concerned is processed as an ordinary frame which does not include the VLAN tag header), and TCI IIIb (TCI is tag control information: consisting of 2 bytes, including 3-bit user priority, 1-bit indicator, and 12-bit VID for identifying the VLAN in which the frame belongs to).

The L3 header is information of 20 bits or more (the length of an option part is variable) shown in FIG. 4.

Referring back to FIGS. 1, 2, MAC interface 1 checks the CRC for the transmission lines in the received frame, and confirms the validity. When the frame is confirmed valid, the frame is forwarded to a header substitution section 2 after the CRC for the transmission lines is deleted (step S2).

Header substitution section 2 forwards the headers (L2 header, L3 header) to a destination search section 3 (step S3).

Destination search section 3 searches for the headers received, and returns the search result to header substitution section 2 (step S4).

Header substitution section 2 performs a substitution operation according to the search result (step S5).

Here, as the header substitution processing, the following header substitution operation according to the relay processing is performed.

In case of the L2 relay:

(L2 header): Attachment/detachment of the VLAN tag III (FIG. 3).

(L3 header): No operation.

In case of the L3 relay:

(L2 header): Substitution of both the destination MAC address I and the source MAC address II.

(L3 header): Subtraction of TTL (time to live), and calculation of IP header checksum.

The frame on which the header substitution operation is completed is stored in a shared memory 4 (step S6).

Next, a MAC interface 5 on the transmission side fetches the frame from shared memory 4, and calculates a CRC for the transmission lines (step S7).

MAC interface 5 on the transmission side adds the CRC calculated in the above step S7 to the frame, and transmits the frame to the transmission line (step S8).

Here, according to the configuration and the processes shown in FIG. 1 through FIG. 4, if no parity bit for data guarantee is provided, it is not possible to detect any data error when the error occurs after the CRC check is performed by MAC interface 1 on the reception side (the above step S2).

Further, even when the parity bits are provided, data errors cannot be detected when a bit error occurs inside the section of the relay equipment before producing the parity bits, or when an even number of bit errors occur in the section guaranteed by the parity bits.

Therefore, once such a data error(s) occurs, a frame having an incorrect data content may undesirably be processed as a normal frame without error detection. When such an event happens in a network system like a financial system requiring high reliability, such an inconvenience may bring about a serious social problem.

Meanwhile, as techniques related to the above, the inventions disclosed in the official gazette of the Japanese Unexamined Patent Publication Nos. 2003-273,840 (which is referred to as patent document 1) and Hei-9-36,841 (which is referred to as patent document 2), respectively, are known. Both the inventions described in the patent documents 1, 2 relate to, and aim at, data protection in the equipment using inspection codes (CRC, parity, etc.) Namely, the data in the equipment are protected by adding an error detection code to the received data.

However, in a system in which data contents are not changed inside the equipment (for example, a communication interface card for IEEE 1394 described in the above patent document 1), the received data is forwarded without modification, or simply after separation. In other words, header substitution is not performed.

In a system in which data contents (header) are changed inside the equipment, for example, network equipment such as a router and a switch, substitutions of a MAC header and an IP header are necessary. This requires overall data protection including during such processing.

However, according to the inventions described in the patent documents 1, 2, it is difficult to apply to the systems in which data contents are changed inside the equipment.

### SUMMARY OF THE INVENTION

Accordingly, considering the above, it is an object of the present invention to provide a data protection method for protecting overall data in a system in which data contents are changed in equipment, and relay equipment using the method.

In particular, it is an object of the present invention to provide a data protection method for data protection in a system in which a header is changed as data contents, and equipment using the above data protection method.

As a first aspect of the data protection method, and the relay equipment using the method, in accordance with the present invention to achieve the above objects, the relay equipment of a store-and-forward system and the data protection method of the relay equipment, in which received frames are temporarily stored in a buffer memory and then forwarded, include: a MAC interface inspecting cyclic redundancy check bits for transmission lines in each received frame; a first CRC inspection section deciding a data part on which no operation is to be performed in the relay equipment in the frame having the cyclic redundancy check bits for the transmission lines being decided as normal in the MAC interface, calculating cyclic redundancy check bits for inside the equipment, and replacing the cyclic redundancy check bits for the transmission lines by the calculated cyclic redundancy check bits for inside the equipment, so as to add to the data part on which no operation is to be performed in the relay equipment; a header substitution section substituting the header of the frame in which the cyclic redundancy check bits for inside the equipment are substituted and added to the data part by the first CRC inspection section; a shared memory for temporarily storing the frame of which header is substituted by the header substitution section; and a second CRC inspection section reading out the stored data from the shared memory, calculating cyclic redundancy check bits for the transmission lines, inspecting the cyclic redundancy check bits for inside the equipment, and if the inspection result is normal, replacing the cyclic redundancy check bits for inside the equipment by the calculated cyclic redundancy check bits for the transmission lines.

As a second aspect of the data protection method, and the relay equipment using the method, in accordance with the present invention to achieve the above objects, in addition to the above first aspect, the CRC inspection section decides that the received frame is an object for L2 relay processing when the destination MAC address in the received frame header does not specify the self-station, and that the received frame is an object for L3 relay processing when destined to the self-station with the type indicating the IP address.

Further, as a third aspect of the data protection method, and the relay equipment using the method, in accordance with the present invention to achieve the above objects, in addition to the above second aspect, the data part on which no operation is to be performed in the relay equipment denotes a part other than the part on which substitution operation is performed, and when the processing to be performed in the equipment is the L2 relay processing, the header substitution is performed on the L2 header of the received frame.

Still further, as a fourth aspect of the data protection method, and the relay equipment using the method, in accordance with the present invention to achieve the above objects, in addition to the above second aspect, the data part on which no operation is to be performed in the relay equipment denotes a part other than the part on which substitution operation is performed, and when the processing to be performed in the equipment is the L3 relay processing, the header substitution is performed on both the L2 header and the L3 header of the received frame.

Further scopes and features of the present invention will become more apparent by the following description of the embodiments with the accompanied drawings.

### BRIEF DESCRIPTION OF THE DRAWINGS

FIG. 1 shows an exemplary configuration block diagram of a store-and-forward system as the conventional example.

FIG. 2 shows a diagram illustrating a frame flow in the relay equipment shown in FIG. 1.

FIG. 3 shows a diagram illustrating the detail of a frame having a CRC for the transmission lines.

FIG. 4 shows a diagram illustrating an L3 (IP) header configuration.

FIG. 5 shows a diagram illustrating one example of a relay equipment configuration according to the present invention.

FIG. 6 shows a process flow (part 1) in the configuration of the embodiment shown in FIG. 5.

FIG. 7 shows a process flow (part 2) in the configuration of the embodiment shown in FIG. 5.

FIG. 8 shows a diagram (part 1) explaining changes of a frame and a footer corresponding to the process flows shown in FIGS. 6, 7.

FIG. 9 shows a diagram (part 2) explaining changes of a frame and a footer corresponding to the process flows shown in FIGS. 6, 7.

FIG. 10 shows a diagram illustrating a typical connection example of relay equipment.

FIG. 11A, 11B show diagrams illustrating relay processing in MAC interface 1.

FIG. 12A, 12B show diagrams illustrating L2 relay processing.

FIG. 13 shows a diagram illustrating an example of a learning table.

FIG. 14A, 14B show diagrams illustrating L3 relay processing.

FIG. 15 shows a diagram illustrating an example of an IP routing table.

FIG. 16 shows a diagram illustrating an example of an ARP table.

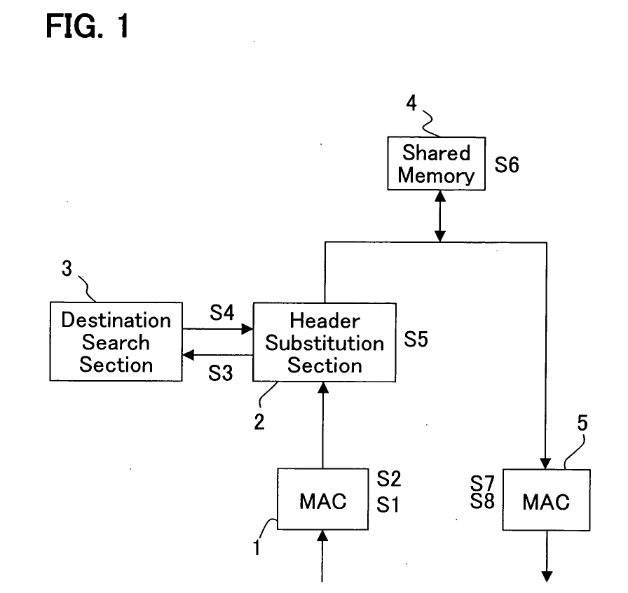

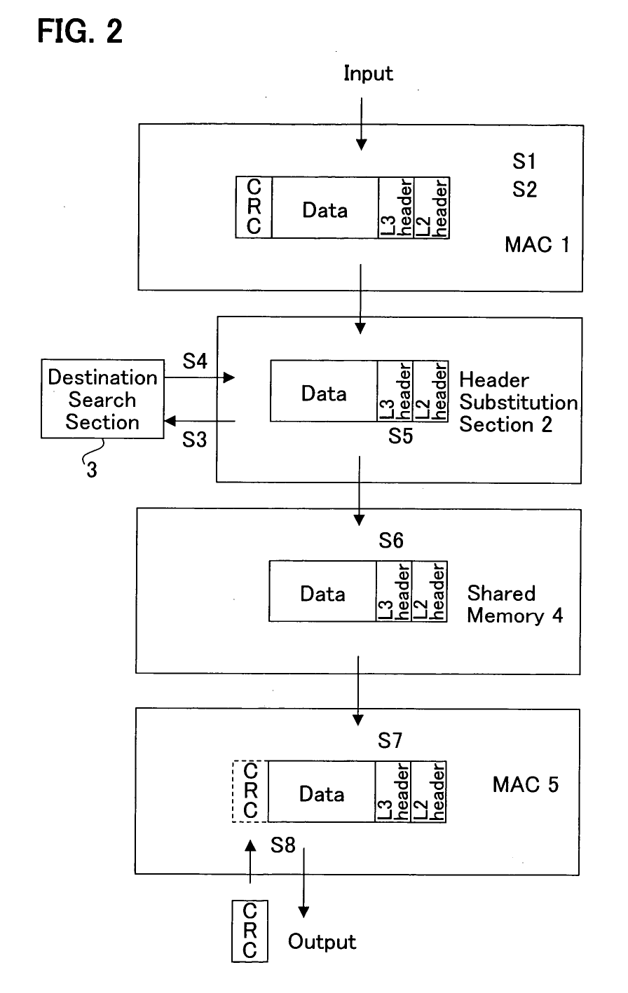

### DETAILED DESCRIPTION OF THE INVENTION

The preferred embodiment of the present invention is described herein after referring to the charts and drawings. However, it is noted that the embodiments illustrated are disclosed merely for the sake of understanding of the present invention, and the technical scope of the present invention is not limited to the embodiments described below.

Here, the basic concept of the present invention is summarized below before the detailed explanation. In relay equipment including router, L3 switch and L2 switch, a header substitution operation is necessary for performing the relay processing of frames. Since the data content in a header part changes, the circuit becomes complicated to enable data protection including the header part.

Therefore, according to the present invention, data protection is performed with the limitation of the data part, which is not an object for substitution operation inside the equipment and has an unchanged content. As to the frame received, the part on which no operation is performed inside the equipment is determined, and the CRC for the part concerned is calculated. The obtained CRC is added to a CRC for inside the equipment in the frame. Thus, a data error produced inside the equipment is detected for the part on which no operation is performed.

Meanwhile, a data error produced in the header part of the substitution object in the equipment is not protected by the above CRC for inside the equipment. However, the header part is inspected through the protocol processing. As a result, the entire data including both the part to be operated and not to be operated can be protected.

Further, by using both the CRC for inside the equipment and the CRC for the transmission lines in combination, so that the frames transmitted through the equipment are protected by either one of the above CRCs, it becomes possible to completely eliminate any non-guaranteed section, such as a section before the parity bits are generated, from inside the equipment.

### EMBODIMENTS

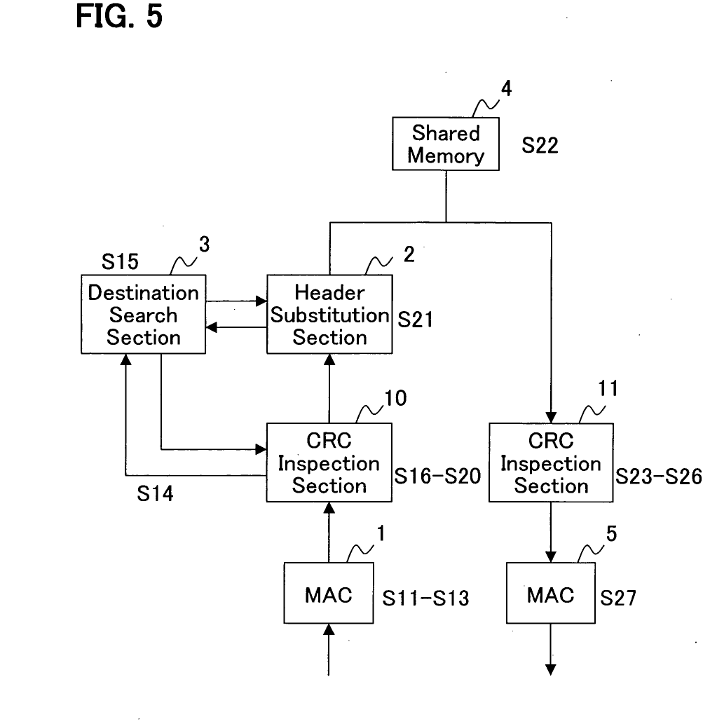

In FIG. 5, an example of a relay equipment configuration according to the present invention is shown. It is noted that, although the configuration shown here is the relay equipment of a shared memory configuration, the present invention is not limited to this configuration, but can be realized in a configuration of cross-point connection.

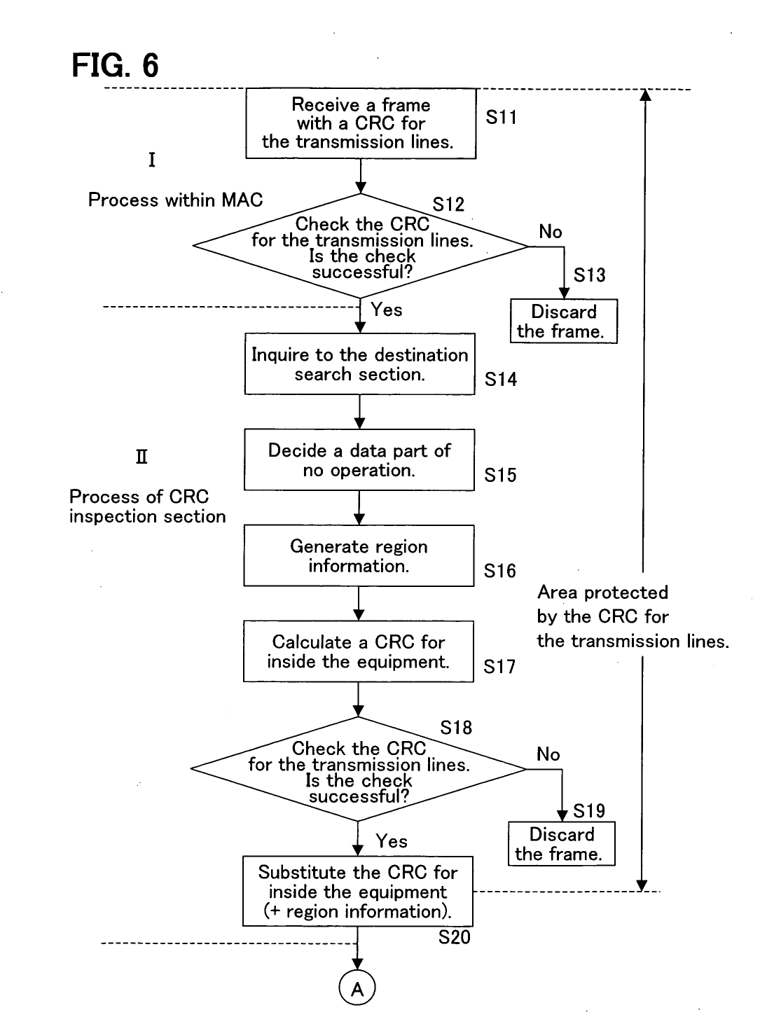

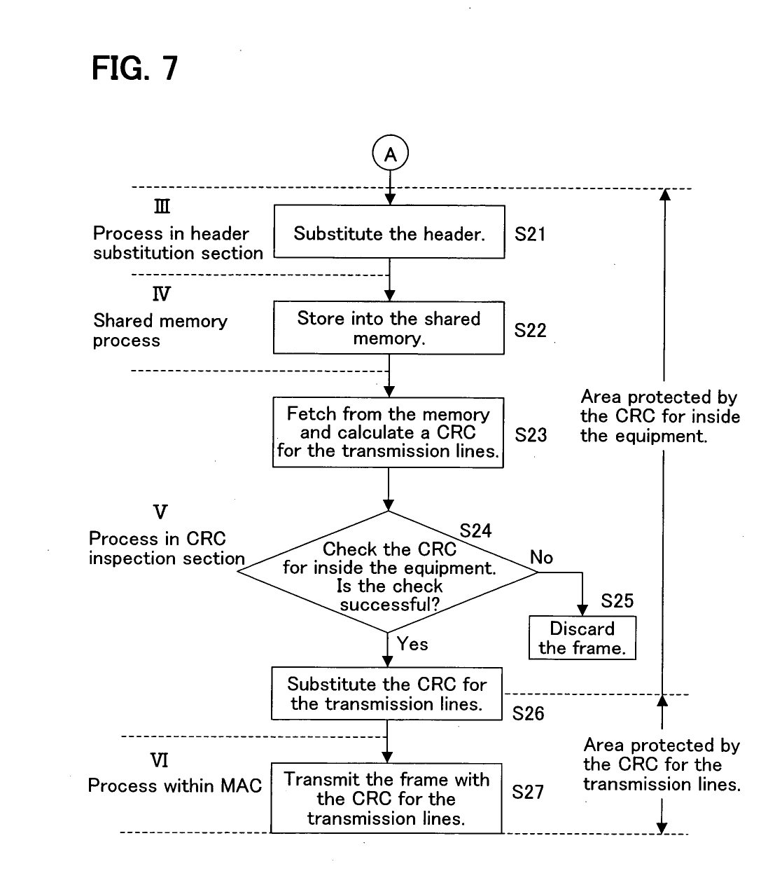

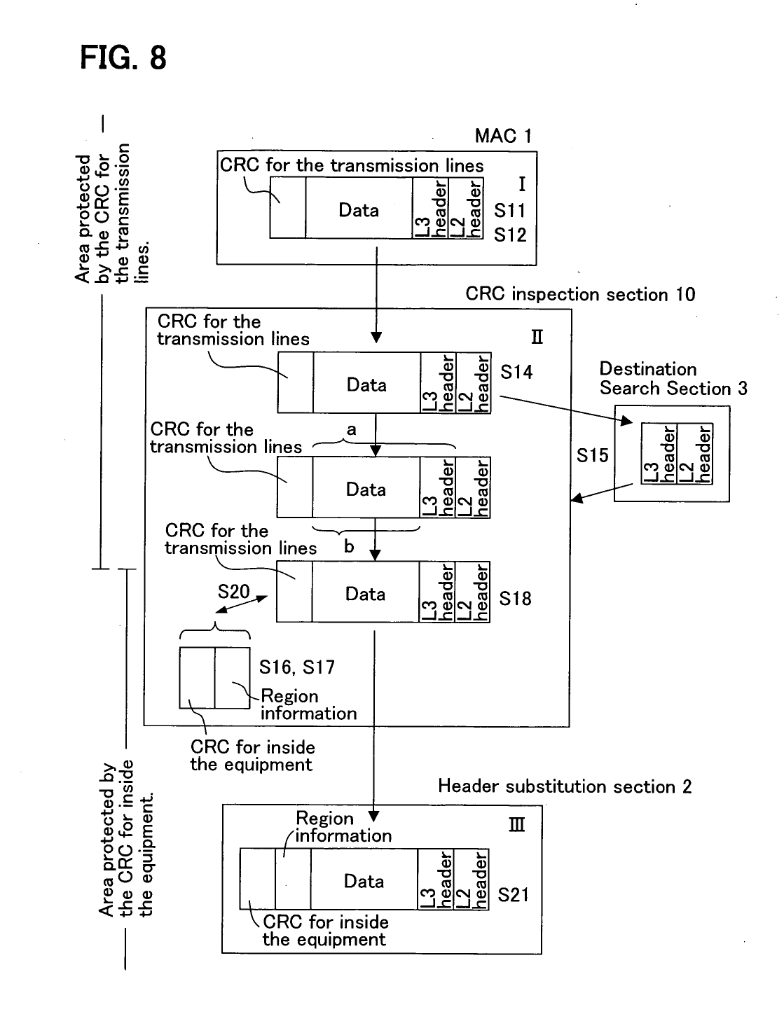

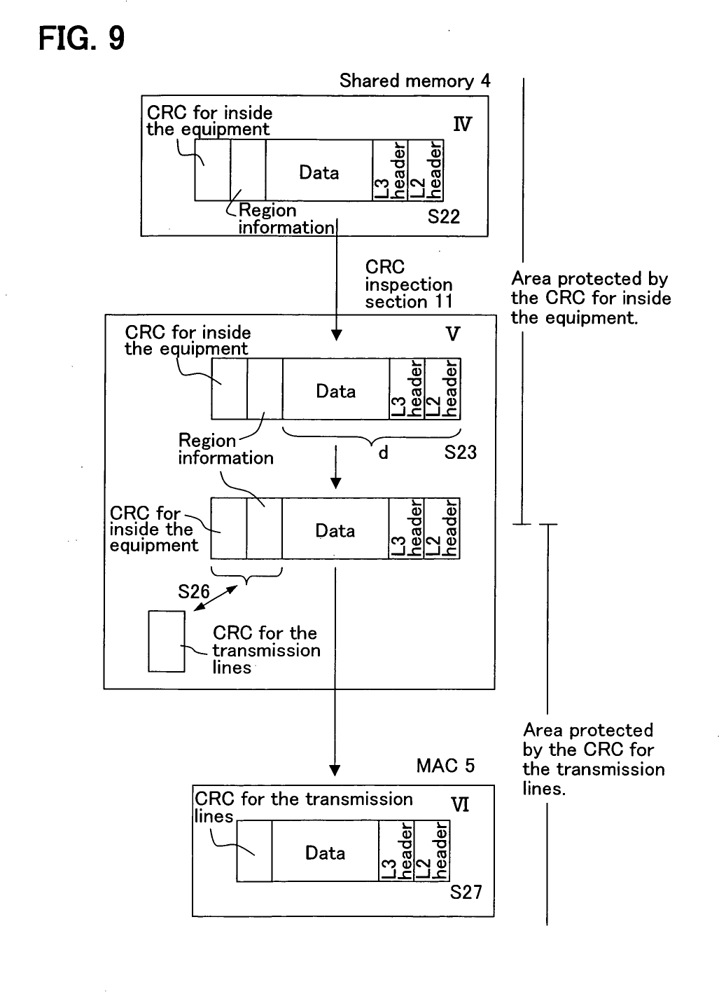

FIGS. 6, 7 are processing flows in the exemplary configuration of the embodiment shown in FIG. 5. Also, FIGS. 8, 9 are diagrams explaining changes of a frame or a footer, corresponding to the process flows shown in FIGS. 6, 7. The processing flow is explained below referring to the above figures.

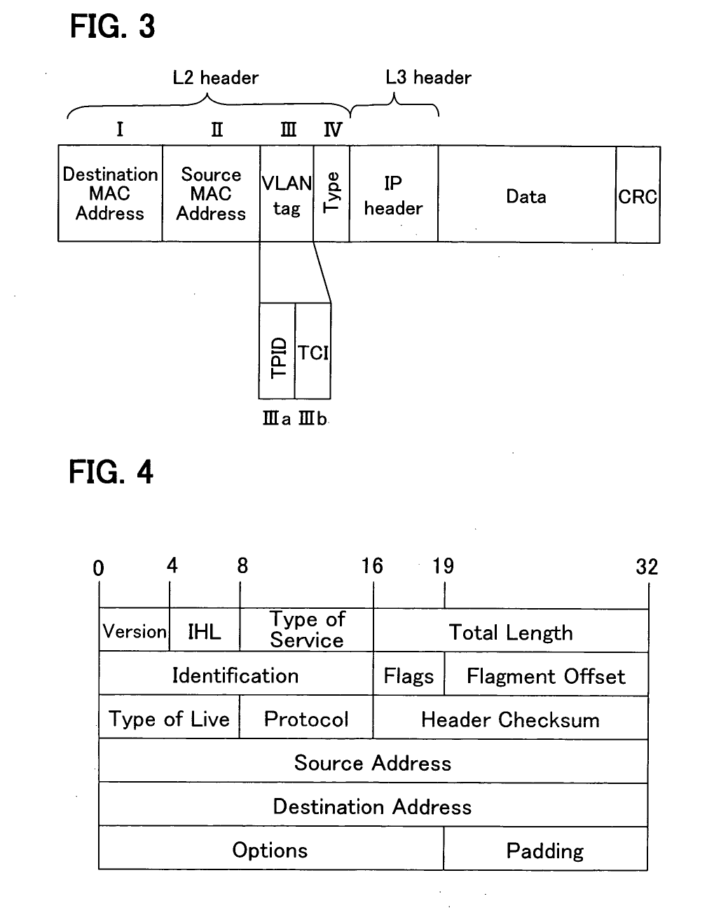

In FIG. 6, as a process I, a frame having a CRC for the transmission lines (refer to FIG. 3) is received in a MAC interface 1 (step S11), and the validity is confirmed by inspecting the CRC for the transmission lines of the received frame (step S12). When the validity cannot be confirmed (No in step S12), the frame is discarded (step S13).

Next, after the validity is confirmed, the frame is forwarded to a CRC inspection section 10. Here, as a process II in a CRC inspection section 10, the CRC for the transmission lines being existent at the time of reception remains unchanged until step S20.

CRC inspection section 10 forwards the header part to a destination search section 3.

Destination search section performs search and decision. The search result is forwarded to CRC inspection section 10 and inquired (step S14). CRC inspection section 10 decides the data part on which no operation is performed (step S15).

Here, relay equipment such as router, L3 (layer 3) switch and L2 (layer 2) switch performs L2 relay processing or L3 relay processing. In case of the L2 relay processing, the L2 header is substituted, while in case of the L3 relay processing, the L3 header is substituted. Here, the part on which no operation is performed inside the equipment denotes a part other than the object part of the above substitution operation.

In FIG. 8, ‘a’, namely L3 header+data, is a portion on which no operation is performed in case of the L2 relay processing. Also, ‘b’ is a portion on which no operation is performed in case of the L3 relay processing, consisting of the data part only.

From the search result, CRC inspection section 10 generates range information indicating the range in the frame to which the CRC for inside the equipment is to be calculated (step S16). As will be described later, by use of the range information added to the frame when the inspection of the CRC for inside the equipment is performed, it is possible to know the calculation range of the CRC for inside the equipment.

Next, the CRC for inside the equipment is calculated based on the above range information being added to the data part of the frame on which no operation is performed inside the equipment (step S17).

After the CRC for inside the equipment is calculated, the CRC for the transmission lines is inspected and the data validity is confirmed (step S18). When the validity cannot be confirmed, the frame is discarded (step S19).

On completion of confirming the validity, the CRC for the transmission lines in the footer part of the frame is replaced by the CRC for inside the equipment and the range information (step S20). Before the footer part is replaced in this step S20, the frame content is protected by the CRC for the transmission lines.

Next, after the footer is replaced, the frame is forwarded to a header substitution section 2.

Following the flow shown in FIG. 7, as a process III of header substitution section 2, a header substitution operation necessary for relay processing is performed (step S21). As a process IV, the frame on which the header substitution is completed is stored into a shared memory 4.

Next, as a process V, in a CRC inspection section 11, the frame is fetched from shared memory 4, and the CRC for the transmission lines is calculated (step S23). As shown in ‘d’ of FIG. 9, the CRC for the transmission lines covers the range including the data, the L3 header and the L2 header.

After the CRC for the transmission lines is calculated, the CRC for inside the equipment is inspected by referring to the range information being added to the frame, and thus the data validity is confirmed (step S24). When the validity cannot be confirmed, the frame concerned is discarded (step S25).

When the validity is confirmed, the frame footer is replaced by the CRC for the transmission lines, which is calculated before in step S23 (step S26). Accordingly, from the preceding step S20 to step S26 in which the CRC for the transmission lines is substituted, the frame is protected by the CRC for inside the equipment.

The frame of which footer part is replaced by the CRC for the transmission lines in step S26 is forwarded to a MAC interface 5, and as a process VI, the frame on which the footer part of the CRC for the transmission lines is added is forwarded to a transmission line (step S27).

By the above-mentioned processes according to the present invention, an error produced on the data part on which no operation is performed in the equipment can be detected by the CRC for inside the equipment. As for the header part on which operations are performed in the equipment, although the information is not protected by the CRC for inside the equipment, the inspection mechanism in the protocol performs an equivalent protection function. In the following, the inspection mechanism against a data error in the header part will be described. An error in the IP header is inspected by a header checksum of the IP header. When any error is detected, the frame is discarded.

In regard to a MAC header error, when there is an error in the VLAN-ID or the destination address, the frame does not reach, and a retransmission process is performed. Thus, an action substantially equivalent to the discard process is performed. In such a way, the error in the header part produced in the equipment is inspected through the protocol processing.

In the relay equipment on which the above method is implemented, as can be understood from FIGS. 8, 9, the data are continuously protected by either the CRC for the transmission lines or the CRC for inside the equipment, using the combination of the two kinds of CRCs. Thus, data protection through the entire sections in the equipment is guaranteed.

Now, a typical example of the determination in the L2 relay processing and the L3 relay processing according to the present invention will be described hereafter.

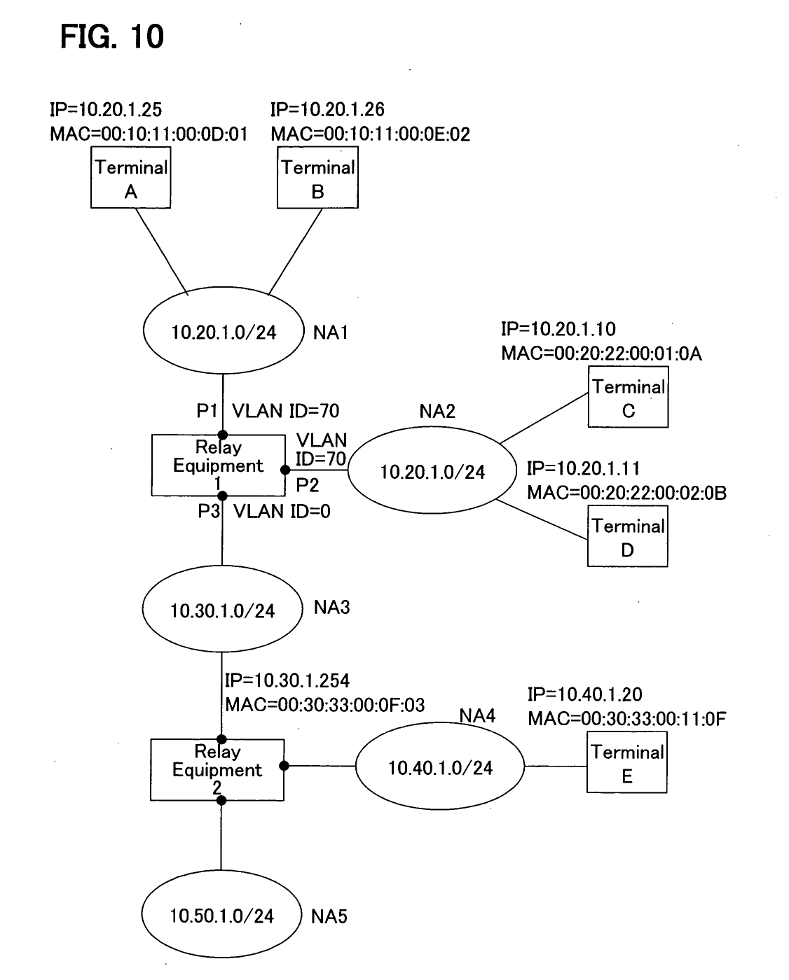

FIG. 10 is a diagram illustrating a typical connection example of the relay equipment, in which terminals A-E are connected by relay equipment 1, 2.

As an embodiment, network addresses NA1-NA5, VLAN addresses of ports P1-P3 of relay equipment 1, IP addresses and MAC addresses of the terminals A-E are as shown in FIG. 10.

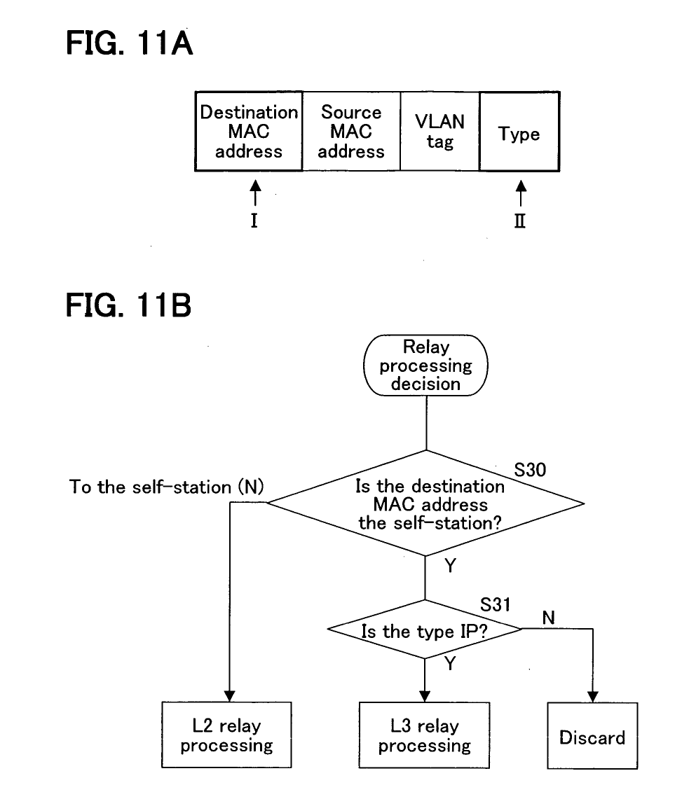

FIG. 11A, 11B are diagrams illustrating the relay processing according to the present invention. In FIG. 11A, only an L2 header part out of the frame having a CRC for the transmission lines is shown. FIG. 11B is a process flow of the relay processing according to the present invention. A MAC address I and a type II in the L2 header shown in FIG. 11A are objects for determination, and whether the destination MAC address is directed to the self-station is determined. If the destination MAC address is not the self-station (N in step S30), the frame is determined as an object for L2 relay processing.

If the destination is the self-station and the type is IP (Y in step S31), the L3 relay processing (IP routing) is to be performed. Otherwise, the frame is discarded (N in step S31).

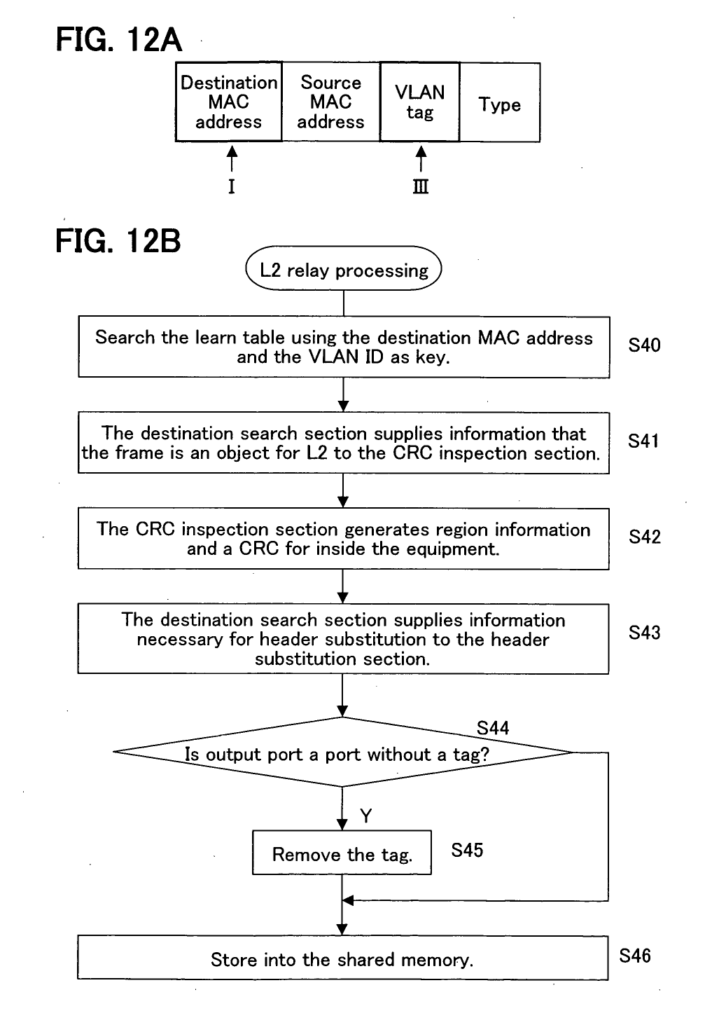

FIG. 12A, 12B show diagrams illustrating the L2 relay processing.

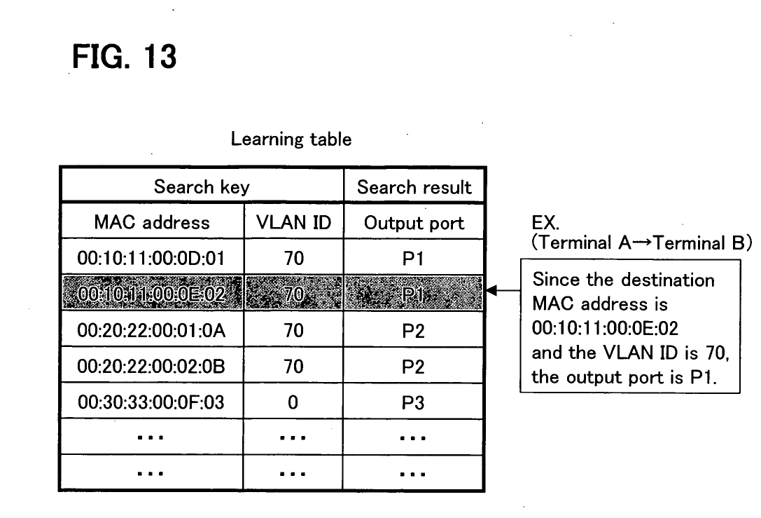

In a destination search section 3, a learning table shown in FIG. 13 is searched by use of a destination MAC address I and a VLAN tag III as keys. The learning table has a search key A, which includes the MAC address and the VLAN address, with a corresponding search result B. Accordingly, in the L2 relay processing shown in FIG. 12B, referring to the learning table, an output port corresponding to the combination of the destination MAC address I and the VLAN ID III (refer to FIG. 12A) is searched (step S40).

For example, when connecting from the terminal A to the terminal B, since the destination MAC address is (00:10:11:00:0E:02) and the VLAN ID is 70, the output port becomes P1 (refer to FIG. 13).

Destination search section 3 supplies to CRC inspection section 10 the information to the effect that the frame is an object for L2 processing (step S41). Based on the information from destination search section 3, CRC inspection section 10 generates range information and a CRC for inside the equipment (step S42).

Next, destination search section 3 supplies information necessary for header substitution to header substitution section 2 (step S43). Based on the supplied information, if the output port is a non-tagged port (Y in step S44), header substitution section 2 deletes the tag (step S45). If otherwise, header substitution section 2 stores the frame into shared memory 4 without modification (step S46).

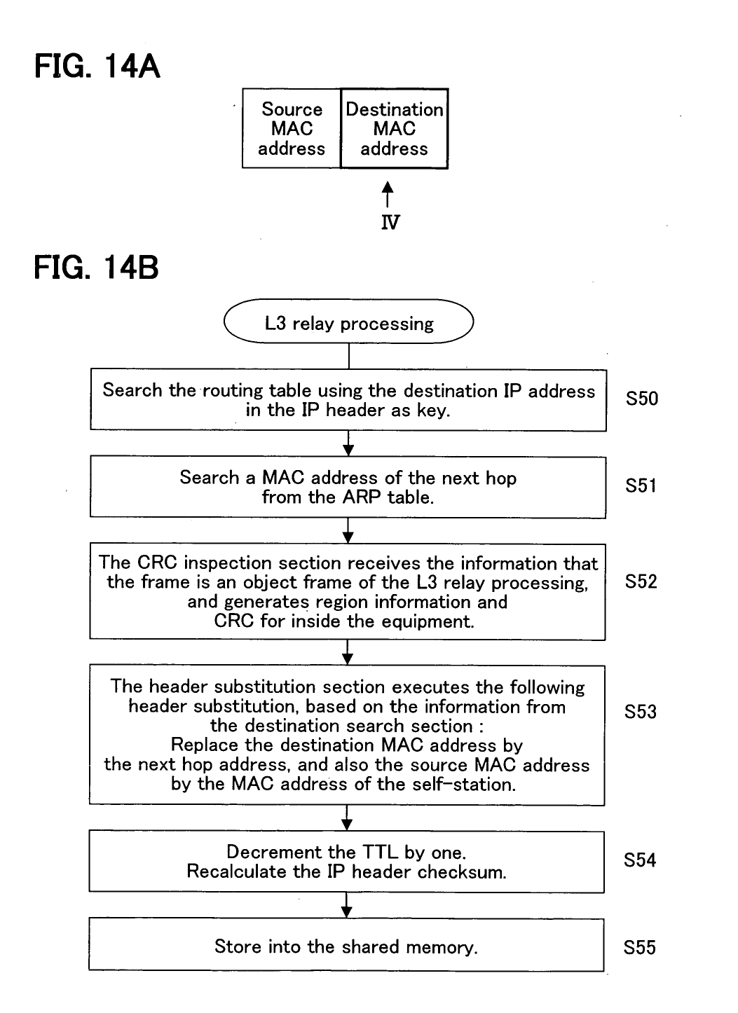

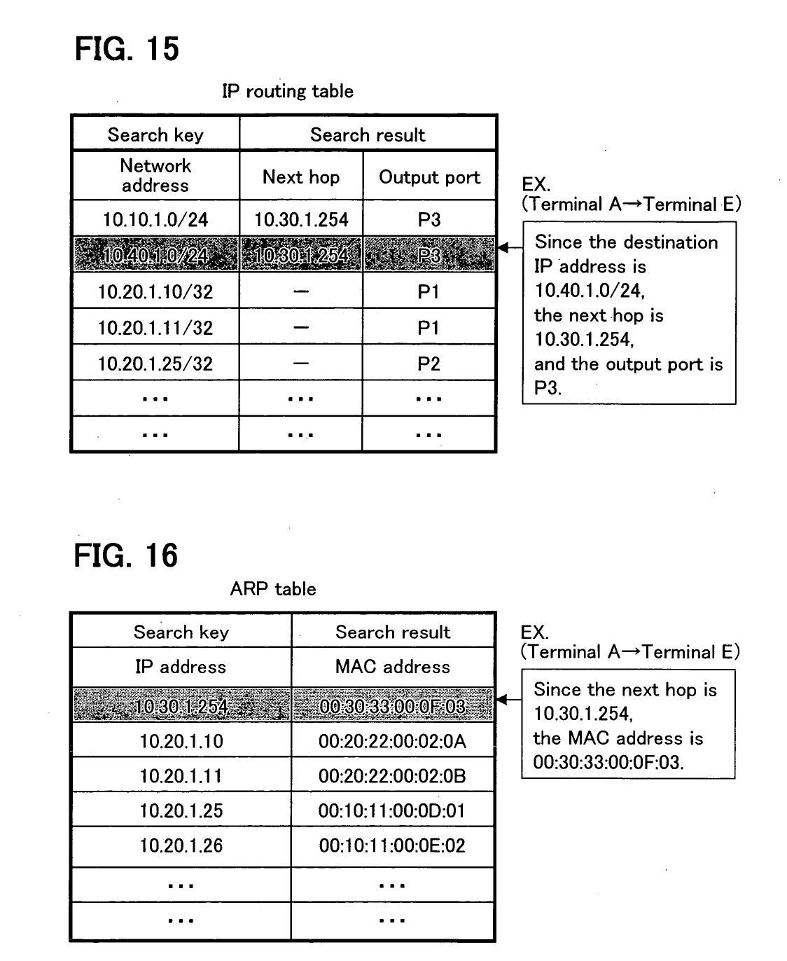

Meanwhile, FIGS. 14A, 14B are diagrams illustrating the L3 relay processing. Here, the L3 header shown in FIG. 3 is constituted of a source IP address and a destination IP address. In the L3 relay processing shown in FIG. 14B, first, destination search section 3 searches an IP routing table shown in FIG. 15 using a destination IP address IV as key, and obtains a corresponding next hop B and an output port C (step S50).

For example, when connecting from the terminal A to the terminal E, since the destination IP address is (10.40.1.20), using the corresponding network address (10.40.1.0/24) as the search key A, information of the next hop (0.30.1.254) and the output port P3 are obtained from the IP routing table.

Next, an ARP table is referred to and the MAC address of the next hop is searched (step S51).

FIG. 16 is one example of the ARP table. For example, in an exemplary case of connecting from the terminal A to the terminal E, because the next hop is (10.30.1.254), the corresponding MAC address of (00.30.33.00.0F.03) is detected.

Next, on receipt of the information from destination search section 3 to the effect that the frame is an object for the L3 relay, CRC inspection section 10 generates range information and a CRC for inside the equipment (step S52). Based on the information from destination search section 3, header substitution section 2 executes the following header substitution process (step S53).

Namely, header substitution section 2 replaces the destination MAC address by the next hop address, and also replaces the source MAC address by the MAC address of the self-station. Further, header substitution section 2 decrements the TTL by one, recalculates the IP header checksum (step S54), and stores the frame into shared memory 4 (step S55).

As the present invention has been described above, the following effects may be expected by use of the method and the equipment according to the present invention. Though a non-guaranteed section exists inside the equipment in the conventional relay equipment, by combining two kinds of CRCs, i.e. CRC for the transmission lines and CRC for inside the equipment, it becomes possible to eliminate such a non-guaranteed section in the relay equipment of the present invention.

Further, it becomes possible to detect an even number of bit errors which cannot be detected by the parity bits.

Even the data are damaged, the frame concerned is inevitably discarded, and therefore it is possible to avoid a situation such that a frame having an incorrect data content is processed as if a normal frame without detection of the error, and thus the error problem can be prevented from being spread.

Although, differently from the method of the present invention, another method of protecting the frame including the header as a whole using CRC for inside the equipment can be considered, the system based on the present invention can be realized with a simpler circuit.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. Store-and-forward relay equipment in which received frames are temporarily stored in a buffer memory and then forwarded, comprising:
a MAC interface inspecting cyclic redundancy check bits for transmission lines in each received frame;
a first CRC inspection section deciding a data part on which no operation is to be performed in the relay equipment in a frame having the cyclic redundancy check bits for transmission lines being decided as normal in the MAC interface, calculating cyclic redundancy check bits for inside the relay equipment, and replacing the cyclic redundancy check bits for the transmission lines by the calculated cyclic redundancy check bits for inside the relay equipment, so as to add to the data part on which no operation is to be performed in the relay equipment;
a header substitution section substituting the header of the frame in which the cyclic redundancy check bits for inside the relay equipment are substituted and added to the data part by the first CRC inspection section;
a shared memory for temporarily storing the frame of which header is substituted by the header substitution section; and
a second CRC inspection section reading out the stored data from the shared memory, calculating cyclic redundancy check bits for the transmission lines, inspecting the cyclic redundancy check bits for inside the equipment, and if the inspection result is normal, replacing the cyclic redundancy check bits for inside the equipment by the calculated cyclic redundancy check bits for the transmission lines.

2. The relay equipment according to claim 1,
wherein the CRC inspection section decides that the received frame is an object for L2 relay processing when the destination MAC address in the received frame header does not specify the self-station, and that the received frame is an object for L3 relay processing when destined to the self-station with the type indicating the IP address.

3. The relay equipment according to claim 2,
wherein the data part on which no operation is to be performed in the relay equipment denotes a part other than the part on which substitution operation is performed, and when the processing to be performed in the equipment is the L2 relay processing, the header substitution performed by the header substitution section is performed on the L2 header of the received frame.

4. The relay equipment according to claim 2,
wherein the data part on which no operation is to be performed in the relay equipment denotes a part other than the part on which substitution operation is performed, and when the processing to be performed in the equipment is the L3 relay processing, the header substitution performed by the header substitution section is performed on both the L2 header and the L3 header of the received frame.

5. A data protection method for store-and-forward relay equipment in which received frames are temporarily stored in a buffer memory and then forwarded, comprising the steps of:
inspecting cyclic redundancy check bits for transmission lines in each received frame;
deciding a data part on which no operation is to be performed in the relay equipment in a frame having the cyclic redundancy check bits for the transmission lines being decided as normal in the inspection of the cyclic redundancy check bits;
in regard to the data part on which no operation is to be performed in the relay equipment, calculating cyclic redundancy check bits for inside the relay equipment; and
replacing the cyclic redundancy check bits for transmission lines by the calculated cyclic redundancy check bits for inside the relay equipment, so as to add to the data part on which no operation is to be performed in the relay equipment;
substituting the header of the frame in which the cyclic redundancy check bits for inside the equipment are substituted and added to the data part;
storing the frame of which header is substituted by the header substitution section temporarily into a shared memory;
reading out the stored data from the shared memory, and calculating cyclic redundancy check bits for the transmission lines; and
inspecting the cyclic redundancy check bits for inside the equipment, and if the inspection result is normal, replacing the cyclic redundancy check bits for inside the equipment by the calculated cyclic redundancy check bits for the transmission lines.

6. The data protection method for the relay equipment according to claim 5,
wherein the step for deciding the data part of no operation to be performed in the relay equipment further decides that the frame is an object for L2 relay processing when the destination MAC address in the header part of the received frame does not specify the self-station, and that the frame is an object for L3 relay processing when destined to the self-station with the type indicating the IP address.

7. The data protection method for the relay equipment according to claim 6,
wherein the data part on which no operation is to be performed in the relay equipment denotes a part other than the part on which substitution operation is performed, and when the processing to be performed in the equipment is the L2 relay processing, the header substitution is performed on the L2 header of the received frame.

8. The data protection method for the relay equipment according to claim 6,
wherein the data part on which no operation is to be performed in the relay equipment denotes a part other than the part on which substitution operation is performed, and when the processing to be performed in the equipment is the L3 relay processing, the header substitution is performed on both the L2 header and the L3 header of the received frame.
